(19) United States
(12) Patent Application Publication
(10) Pub. No.: US 2009/0048866 A1
(43) Pub. Date: Feb. 19, 2009

(54) Rules-Based System For Routing Evidence and Recommendation Information to Patients and Physicians By a Specialist Based on Mining Report Text

(76) Inventors: Prakash Mahesh, Hoffinan Estates, IL (US); Murali K. Kariathungal, Hoffinan Estates, IL (US); Mark M. Morita, Arlington Heights, IL (US)

Correspondence Address: MCANDREWS HELD & MALLOY, LTD, 500 WEST MADISON STREET, SUITE 3400, CHICAGO, IL, 60661, US

(21) Appl. No.: 11/840,364

(22) Filed: Aug. 17, 2007

(51) Int. Cl. G06Q 50/00

(52) U.S. Cl. 705/2

(57) ABSTRACT

One or more of the embodiments of the present invention provide a rules-based system for routing medical reports based on processing report data. Certain embodiments of the invention provide a medical report routing system including a report acquisition component, a language processing component, a routing rule component, and a report transmitting component. The report acquisition component is adapted to receive a medical report. The language processing component adapted to apply natural language processing techniques to the medical report. The routing rule component is adapted to apply at least one routing rule to said medical report

### BACKGROUND OF THE INVENTION

The present invention generally relates to a report transmission system. In particular, the present invention relates to an image and report transmission system with clinical data mining capabilities to route evidence and recommendation information to patients and physicians based upon mining report text.

Healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example.

The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

In one example, a radiologist may use one or more imaging modalities to acquire images of a patient's anatomy. The radiologist then begins to review the images and creates a complete medical report based on the acquired images of the patient's anatomy. When the radiologist completes the medical report, the report must be sent to other physicians for further review and action. Additionally, a specialist or a patient may require a copy of the report as well. The preliminary report distribution is typically determined by identity of the patient's referring physician. After completing a medical report, a radiologist will determine the identity of the patient's referring physician and then manually fax or email the referring physician a copy of the medical report. Once the referring physician has received the medical report from the radiologist, the referring physician may then manually forward the report to other physicians, specialists, and/or the patient.

In a healthcare or clinical environment, such as a hospital, a large number of employees and patients may result in confusion or delay when trying to transmit reports to medical personnel for examination, treatment, consultation, or referral, for example. A delay in contacting other medical personnel may result in further injury or death to a patient.

Currently, report distribution to physicians is based on the identity of the patient's general practitioner. The transmission of a report to a medical specialist is a manual and tedious process. Thus current systems and methods of report distribution are tedious and inefficient because they require manual action based solely on the identity of the patient's referring physician.

Thus, there is a need for systems and methods to improve clinical workflow via image and information management with clinical data mining capabilities. Therefore, there is a need for systems and methods for free text searching capability with electronic medical records.

### BRIEF SUMMARY OF THE INVENTION

One or more of the embodiments of the present invention provide a rules-based system for routing medical reports based on processing report data. Certain embodiments of the invention provide a medical report routing system including a report acquisition component, a language processing component, a routing rule component, and a report transmitting component. The report acquisition component is adapted to receive a medical report. The language processing component adapted to apply natural language processing techniques to the medical report. The routing rule component is adapted to apply at least one routing rule to said medical report.

Certain embodiments of the present invention provide a method for automated forwarding of information including receiving information in the form of an electronic report and performing natural language processing on data contained within the electronic report. The natural language processing includes compiling a list of intended report recipients. The report is transmitted to the list of intended report recipients.

Certain embodiments of the invention provide a medical report routing system including a report transmitting component, a report feedback component, and a routing rule editing component. The report feedback component is adapted to receive feedback from a recipient of the medical report. The routing rule editing component edits a routing rule based at least in part on the feedback from the medical report recipient.

These and other features of the present invention are discussed or apparent in the following detailed description.

### BRIEF DESCRIPTION OF SEVERAL VIEWS OF THE DRAWINGS

FIG. 1 illustrates a rules-based medical report routing system according to an embodiment of the present invention.

FIG. 2 illustrates a rules-based medical report routing system with natural language processing capabilities according to an embodiment of the present invention.

FIG. 3 illustrates a method for rules-based routing of medical reports according to an embodiment of the present invention.

FIG. 4 illustrates a method for modifying rules-based routing of medical reports according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

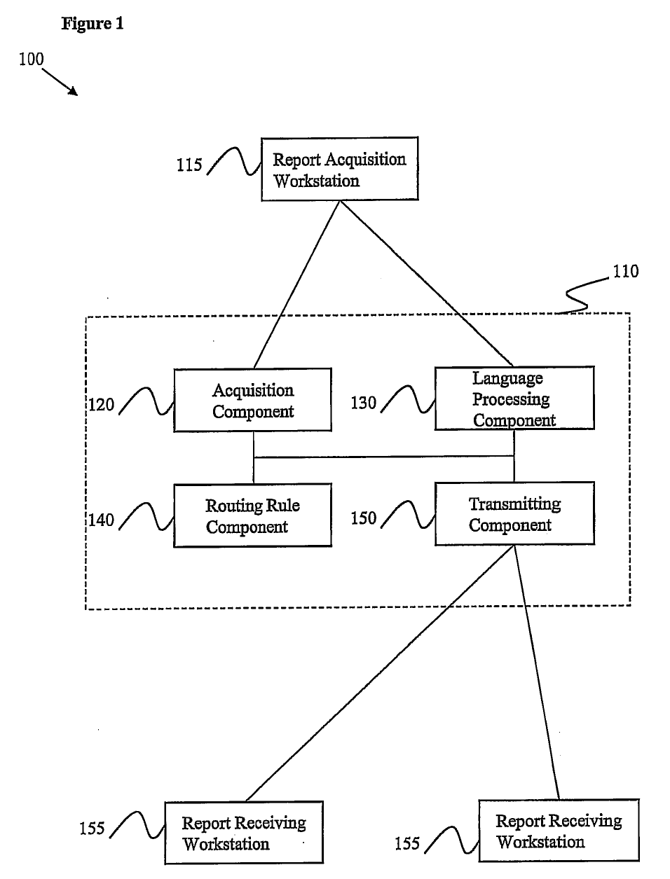

FIG. 1 illustrates a medical report routing system 100 according to an embodiment of the present invention. The report routing system 100 includes a report router 110, a report acquisition device 115, an acquisition component 120, a language processing component 130, a routing rule component 140, a transmitting component 150, and a report receiving workstation 155.

The report router 110 may be one or more computer devices adapted to route medical reports to one or more recipients. More specifically, in one embodiment of the invention the report router 110 may comprise an acquisition component 120, a language processing component 130, a routing rule component 140, and a transmitting component 150. In another example embodiment, the acquisition component 120, the language processing component 130, the routing rule component 140, and the transmitting component 150 may each be separate computer devices while the report router 110 is comprised of a group or network of computers. In one example embodiment, the acquisition component 120 may be a software program capable of capturing an audio output from a microphone device. Furthermore, the acquisition component 120 software may also be capable of translating spoken audio or language into a machine readable format such as text, Unicode, or a binary bit string.

The language processing component 130 may be any processor or software adapted to process, or perform operations on, written or spoken language. In one embodiment, the language processing component 130 operates on audio spoken by a medical professional.

The routing rule component 140 may be any computer device or software adapted to utilize routing rules. Routing rules are hardware or software instructions influencing the transmission of an object. More specifically, routing rules may be used to create a list of intended recipients of a medical report. A simple example of a routing rule provides that all medical reports are transmitted to at least a patient's primary care physician. Another simple example of a routing rule provides that all x-ray reports relating to bone fractures are transmitted to a hospitals orthopedic group. Other routing rules may provide for modification of reports transmitted to particular recipients. For example, a routing rule for medical reports transmitted to a patient's insurance company may require the redaction of portions of the report in order to protect the patient's privacy. In another example embodiment, the routing rule component 140 may receive, create, or edit, a routing rule instructing a medical report to be sent to a medical professional.

The transmitting component 150 may be any computer device or software adapted to transmit an object such as a medical report. The transmitting component may send an object to a person, a remote device such as a pda, a hospital workstation, or another computer system.

The report acquisition device 115 may be any device adapted to acquire the contents of a report. One example of a report acquisition device 115 may be a personal computer. Another example of a report acquisition device 115 is a workstation grade device that is part of a hospital computing system. In one example, the acquisition device 115 contains at least one input device. The input device may be in the form of a keyboard, mouse, trackball, graphics tablet, microphone, or video camera. In yet another example, the report acquisition device 115 may consist of an input device. In one embodiment of the invention, the report acquisition device is a microphone adapted to capture or receive the spoken audio of a medical professional.

The report receiving workstation 155 may be any device adapted to receive the contents of a report. One example of a report receiving workstation 155 may be a personal computer in the form of a desktop or a laptop. Another example of a report receiving workstation 155 may be a computer device that is part of a hospital computing system. The report receiving workstation 155 in one embodiment will contain a receiving component, such as a network adapter, adapted to receive the contents of a medical report. The report receiving workstation 155 in another embodiment will also contain a display component, such as a computer monitor, adapted to display the contents of a report. The workstation 155 may also contain one or more input devices adapted to edit the contents of a report.

In one embodiment of the invention the report router 110 is physically connected to the report acquisition device 115 and the report receiving workstation 155. The physical connection may be a wire or other physical medium capable of transmitting data. One example of a physical connection capable of passing data may be an audio cable connecting a microphone report acquisition device 115 to a soundcard on a computer report router 110. Other embodiments of the invention may allow for an indirect physical connection between the report acquisition device 115 and the report router 110. For example, the report acquisition device 115 and the report router 110 may both be computers connected via a wired Ethernet network. Alternatively, the report router 110 and the report acquisition device may not be physically connected. Instead, the report router 110 and the report acquisition device may communicate via a wireless technology such as Wi-Fi, infrared, or Bluetooth. The acquisition component 120, the language processing component 130, the routing rule component 140, and the transmitting component 150 may be separate computer devices connected via a wired or wireless communication scheme such as the examples provided above. In another example, the acquisition component 120, the language processing component 130, the routing rule component 140, and the transmitting component 150 may be discrete hardware or software components of a single hardware device or software program. In yet another example, the report router 110, the report acquisition device 115, the acquisition component 120, the language processing component 130, the routing rule component 140, the transmitting component 150, and the report receiving workstation 155 are all part of the same device.

In operation, the medical report routing system 100 forwards a medical report to a medical professional as described in the following example. First, a patient with a health need visits a medical professional for treatment. A medical professional may be a physician, doctor, surgeon, radiologist, nurse, orderly, or any other individual employed by a medical institution to attend to the needs of patients. The medical health professional will examine and observe the patient, diagnose medical issues, and identify potential areas of concern or safety factors. Afterwards, the medical health professional decides upon a course of action or provides a recommendation on the future medical care or therapy to resolve the issue. Either after seeing the patient or contemporaneous with visiting the patient, the medical health professional generates a report based at least in part on the medical professional's examination of the patient. A report may also be generated based on another professional's report or notes or a diagnostic procedure such as some form of medical imaging. The medical professional may utilize a report acquisition workstation 115 such as a computer to prepare the report. The medical report will relate to certain patient anatomies, treatment options or recommendations. The report may be handwritten, typed, scanned into a computer, or dictated into a recording device.

In a more specific example, a patient may visit a cardiologist for treatment. In order to properly diagnose the patient's condition, the cardiologist may send the patient to a radiologist for medical imaging, such as a Doppler ultrasound. The radiologist may acquire one or more series of Doppler ultrasound images to observe blood flow around the patient's heart. After acquiring the ultrasound images, the radiologist may generate a report summarizing the observed patient anatomy as well as recommending further treatment and analysis. Additionally, the radiologist may recommend the involvement of medical professionals from other specialized areas. In one embodiment of the invention, the report is generated when a report acquisition 115 workstation comprising a computer system with an audio input device and speech recognition software acquires the spoken language of the radiologist. In an alternative example, the report is generated concurrently with the medical imaging procedure.

After the medical report has been created, the report may need to be forwarded to other medical professionals. Those other medical professionals could be the patient's primary physician, a surgeon, a specialist or any other medical professional. In one embodiment of the invention, the report may be forwarded to the patient. The creator of the report may possess a list of intended recipients when creating the report. This list of intended recipients may be passed on by a referring physician or by the patient. In other circumstances, the medical professional may need to create a list of medical professional recipients. In previous scenarios, the creator of a report manually compiled a list of intended report recipients. The manual compilation took the form of the report creator looking up the contact information for one or more medical professionals from a contact directory. In one embodiment of the invention, the system 100 automatically compiles a list of intended recipients as well as the contact information of the individuals on the list of intended recipients. Other embodiments provide for characterization of the entities on the list of intended recipients. For example, the list of intended recipients may contain a category for the patient and the patient's relatives, a category for the patient's primary care provider, a category for medical specialist(s) selected to treat a diagnosed condition, and a category related to one or more health insurance providers. In certain embodiments of the invention, the information in the medical report may be altered, redacted, and/or modified based on the categories of the intended recipients. For example, the patient category may receive a report that is a condensed version of the report sent to the medical specialist category. In another example, the report transmitted to the health insurance category may redact some of the patient's personal information.

Continuing with the example of the patient visiting a cardiologist, the report generated by the radiologist may need to be transmitted to one or more medical specialists. One embodiment of the invention as illustrated by the system 100 is adapated to automate and/or improve the efficiency of the transmission of the medical report generated by the radiologist. The report acquisition workstation 115 transmits the radiologist's report over a network to the acquisition component 120 of report router 110. The acquisition component 120 provides the report data to the report router 110 and the components comprising the report router 110. The acquisition component 120 communicates with language processing component 130 and/or the routing rule component 140. The language processing component 130 parses the data of the radiologist's report and determines that the report relates to a Doppler ultrasound, cardiac imaging, and identified pathologies. The routing rule component 140 creates a list of intended recipients to transmit the report. The routing rule component 140 may communicate with the acquisition component 120 to utilize data within the report such as specific doctors identified by the radiologist. Additionally, the routing rule component 140 may communicate with the language processing component 130 to utilize the topics or keywords selected from the report by the language processing component 130. The routing rule component 140 creates a list of intended recipients that includes the patient's cardiologist, the patient, the patient's insurance company, and a specialist in a cardiac pathology identified by the radiologist.

A medical report may need to be transmitted to one or more recipients. The recipients may be medical professionals, the patient, and/or insurance administrators. In one embodiment of the invention, the report may be electronically transmitted to one or more recipients via fax, e-mail, or through an internet webpage. The report may be transmitted to the recipients identified by the list of intended recipients described above. In a preferred embodiment, the medical report transmittal is automated. That is, after the list of intended recipients is created, the report may be transmitted to the recipients identified by the list of intended recipients without further input from a system user. The embodiments of the invention provide several advantages over previous systems. Electronic transmittal of a medical report may be faster, more efficient, and more convenient. Automated transmittal more further reduce the time between a patient examination and report receipt by the appropriate medical professional. Previous systems required the physical delivery of paper copies of medical reports which could lead to delays of several hours from report generation to report receipt. Embodiments of the invention may provide for a medical report to be transmitted to the appropriate recipient within seconds after the creation of the medical report. Further, physical delivery of a medical report has a greater risk of delay due to lost paperwork.

Further continuing with the example of the patient visiting a cardiologist, the report generated by the radiologist is transmitted to the list of intended recipients identified by the routing rule component 140. The routing rule component 140 provides the report router 110 with a list of intended recipients of the medical report. The list may be a data file which includes information relating to the intended recipients, such as names, phone numbers, fax numbers, email addresses, instant messaging screennames, etc. The routing rule component 140 can communicate this list of intended recipients to the transmitting component 150. The transmitting component 150 utilizes the data in the list of intended recipients to email the report to one or more medical health professionals who are able to access the report using report workstation(s) 155.

After a medical report has been transmitted, embodiments of the invention provide notification to an intended report recipient. For example, the report routing system may send a SMS text message, email, or other type of electronic notification to the intended recipient indicating that a report has been transmitted to the recipient.

In another embodiment of the invention, the report may be automatically forwarded to the intended recipients after the medical health professional has finished speaking. In this example embodiment, once the medical health professional has indicated that report is complete the medical report is processed, the intended recipients are identified, and the report is transmitted without any further manual input from the report author. No further manual input is required. The medical professional creating the report may indicate that report is complete by speaking a key word or phrase. Because the medical professional does not need to provide further manual input, the medical professional is able to move on to treating/diagnosing other patients in need rather than spending time on recipient identification and report forwarding.

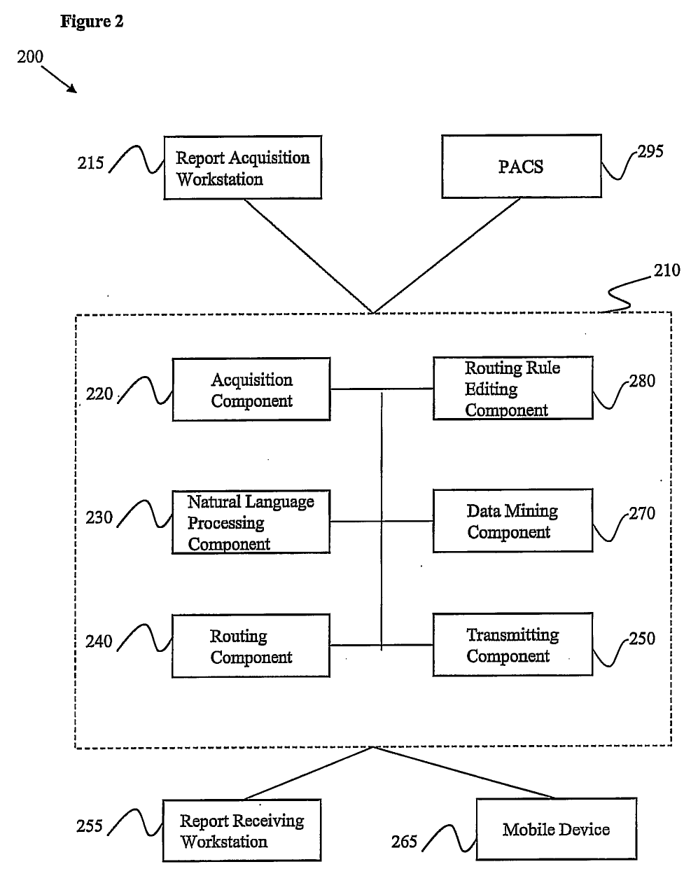

FIG. 2 illustrates a medical report routing system 200 according to an embodiment of the present invention. The report routing system 200 includes a report router 210, a report acquisition workstation 215, an acquisition component 220, a natural language processing component 230, a routing rule component 240, a transmitting component 250, a report receiving workstation 255, a mobile device 265, a data mining component 270, a routing rule editing component 280, and a PACS 295.

The report acquisition workstation 215 and report receiving workstation 255 of report routing system 200 may be similar in composition and operation to the report acquisition workstation 115 and report receiving workstation 155 of report routing system 100. Additionally, the report router 210 along with acquisition component 220, natural language processing component 230, routing rule component 240, and transmitting component 250 of system 200 may be similar in composition and operation to the report router 110 along with acquisition component 120, natural language processing component 130, routing rule component 140, and transmitting component 150 of system 100.

The natural language processing component 230 may be any processor or software adapted to process, or perform operations on, written or spoken language. Additionally, the natural language processing component 230 is adapted to utilize natural language processing techniques. Natural language processing (NLP) is a subfield of artificial intelligence and linguistics. Natural language processing studies the problems of automated generation and understanding of natural human languages. Natural language generation systems convert information from computer databases into normal-sounding human language, and natural language understanding systems convert samples of human language into more formal representations that are easier for computer programs to manipulate.

Natural language processing comprises many different operations performed on language, such as: automatic summarization, foreign language translation, information extraction, information retrieval, machine translation, named entity recognition, natural language generation, optical character recognition, question answering, speech recognition, spoken dialogue management, text simplification, and text to speech.

There are several types of problems natural language processing systems must over come, such as: speech segmentation, text segmentation, word sense disambiguation, syntactic ambiguity, imperfect or irregular input, and recognizing planned or spoken action. Statistical natural language processing uses stochastic, probabilistic and statistical methods to resolve some of the difficulties discussed above, especially those which arise because longer sentences are highly ambiguous when processed with realistic grammars, yielding thousands or millions of possible analyses. Methods for disambiguation often involve the use of corpora and Markov models. The technology for statistical NLP comes mainly from machine learning and data mining, both of which are fields of artificial intelligence that involve learning from data.

The data mining component 270 may be any processor or software adapted to perform data mining. Data mining has been defined as the nontrivial extraction of implicit, previously unknown, and potentially useful information from data. Data mining involves sorting through large amounts of data and picking out relevant information. Data mining identifies trends within data that go beyond simple analysis. Through the use of sophisticated algorithms, users have the ability to identify key attributes of data relationships. The data mining component 270 may be in communication with the PACS 295 or any other hospital information system in order to perform data mining operations on the data sets contained therein. The data mining component 270 may also relate data mining operations from a PACS and/or hospital information system to the data contained within a medical report to perform knowledge discovery or prediction operations.

The term data mining is often used to apply to the two separate processes of knowledge discovery and prediction. Knowledge discovery provides explicit information that has a readable form and can be understood by a user. Forecasting, or predictive modeling provides predictions of future events and may be transparent and readable in some approaches (e.g. rule based systems) and opaque in others such as neural networks. Moreover, some data mining systems such as neural networks are inherently geared towards prediction and pattern recognition, rather than knowledge discovery.

The routing rule editing component 280 may be any software or hardware adapted to modify rules utilized by the routing rule component 240. Routing rules are hardware or software instructions influencing the transmission of an object. More specifically, routing rules may be used to create a list of intended recipients of a medical report or may include instructions relating to the modification and transmission of a medical report. The routing rule editing component 280 may provide an interface for the modification of a routing rule. For example, the routing rule editing component 280 may communicate with the routing rule component 240 and/or a user of the report router 210 to modify an existing rule forwarding Doppler ultrasound images of the heart from one cardiologist to a different cardiologist.

The mobile device 265 may be any handheld or portable electronic device adapted to receive medical reports transmitted by the transmitting component 250. Common examples of mobile devices include pdas, cellphones, smartphones, laptops, etc.

The PACS 295 refers to picture archiving and communication systems (PACS) are computers or networks dedicated to the storage, retrieval, distribution and presentation of images. Typically a PACS network consists of a central server that stores a database containing medical images. The PACS may communicate with client workstations via a LAN, WAN, or Internet connection to provide and/or receive medical images and/or data. The medical images are stored in an independent format. The most common format for image storage is DICOM (Digital Imaging and Communications in Medicine). Many PACS handle images from various modalities, such as ultrasonography, magnetic resonance imaging, positron emission tomography, computed tomography, endoscopy, mammography and radiography (plain X-rays). Additionally many PACS provide a single point of access for images and their associated data. PACS can also interface with existing hospital information systems.

In one embodiment of the invention the report router 210 is physically connected to the report acquisition device 215, report receiving workstation 255 and PACS 295. The physical connection may be a wire or other physical medium capable of transmitting data. For example, the report acquisition device 215, the report router 210, PACS 295, and report receiving workstation 255 may all be computers connected via a wired internet network. Alternatively, the report acquisition device 215, the report router 210, PACS 295, mobile device 265, and report receiving workstation 255 may communicate via a wireless technology such as Wi-Fi, infrared, or Bluetooth.

The acquisition component 220, natural language processing component 230, a routing rule component 240, a transmitting component 250, data mining component 270, and routing rule editing component 280 may be separate computer devices connected via a wired or wireless communication scheme such as the examples provided above. In another example, acquisition component 220, natural language processing component 230, a routing rule component 240, a transmitting component 250, data mining component 270, and routing rule editing component 280 may be discrete hardware or software components of a single hardware device or software program. In yet another example, the report router 210, report acquisition workstation 215, acquisition component 220, natural language processing component 230, routing rule component 240, transmitting component 250, report receiving workstation 255, data mining component 270, routing rule editing component 280, and PACS 295 are all part of the same device.

In operation, the medical report routing system 200 may perform similar to other example embodiments described elsewhere in this application. For example, a patient's general practitioner may instruct the patient to undergo Doppler ultrasound imaging in order to observe cardiac blood flow. The patient visits a radiologist, who performs the Doppler ultrasound procedure. After the procedure, the radiologist prepares and transmits a medical report summarizing the imaging procedure utilizing the medical report routing system 200.

The radiologist uses the report acquisition workstation 215 to prepare the report. For example, the radiologist begins speaking into a microphone connected to the report acquisition workstation 215. The report acquisition workstation 215 captures the spoken word in order to prepare the report. The report acquisition workstation 215 may also access electronic data, such as images and video captured during the Doppler ultrasound in order to prepare the report. Further, the report acquisition workstation 215 may also access other data such as previous medical reports relating to the patient, in order to prepare the report. In one embodiment of the invention, the report acquisition workstation creates the report based on at least one of the spoken word of the radiologist, images and/or video captured during the imaging procedure, and previously acquired data or reports. In another embodiment of the invention, the report acquisition workstation 215 communicates the spoken word of the radiologist, images and/or video captured during the imaging procedure, and previously acquired data or reports to the report router 210 which creates the report.

The acquisition component 220 of the report router 210 receives the data from the report acquisition workstation 215 and provides the received data to the report router 210 and the sub-components of the report router 210. For example, the acquisition component 220 communicates the report to the natural language processing component 230. The natural language processing component 230 process the spoken word of the radiologist to transform the spoken word into a different electronic form. One example embodiment has the natural language processing component 230 transforming the radiologist's spoken words into machine readable text. In order to transform the spoken word into machine readable text, the natural language processing component 230 may need to perform one or more natural language processing techniques as described above. More specifically, the natural language processing component 230 may need to perform speech recognition, named entity recognition, and ambiguity resolution.

Other embodiments may provide foreign language translation. Further embodiments may provide users, such as a radiologist, with interactive natural language processing. For example, while dictating a report, the radiologist may issue spoken commands which are used in the creation of the report rather than added to the report. The radiologist may speak a command such as “delete the last word” or “delete last sentence.” The natural language processing component 230 performs one or more natural language processing functions to interpret and perform the spoken command. For example, the natural language processing component 230 utilizes speech segmentation and recognition to segment and recognize individual words within a string of spoken words, translates the spoken words into machine readable data, resolves word and syntactic ambiguities, and command recognition. More specifically, the natural language processing component 230 recognizes the spoken command and translates the command into a machine readable instruction. The natural language processing component 230 may further perform the recognized command or instruct another component of the report router 210 or the report acquisition workstation 215 to perform the recognized command. In other embodiments of the invention, the natural language processing component 230 may be capable of recognizing predetermined spoken keywords.

The output of the natural language processing component 230 may be communicated to the other components of the report router 210. For example the machine readable output of the natural language processing component 230 may be communicated to the data mining component 270. The data mining component 270 may perform data mining functions on the report data. For example, the data mining component 270 may search the report for knowledge identification, that is, identify data within the report that may be overlooked by a medical professional. The data mining component 270 may also perform prediction functions. The data mining component 270 may examine the data in the report to predict future medical problems. In other embodiments, the data mining component 270 may also communicate with the PACS 295 or other hospital information systems. For example, the data mining component 270 may receive the patient's report and pull the patient's medical history from a hospital information system in order to perform data mining techniques and predict likely health risks to a patient.

As in other example embodiments of the invention, the report routing system 200 utilizes a routing rule component 240 to determine the intended recipients of the medical report and associated data. Further, the routing rule component 240 may modify the medical report and associated data based on the rules contained within the routing rule component 240. Additionally, the system 200 utilizes a transmitting component 250 to transmit a medical report to one or more medical health professionals.

In alternative embodiments of the invention, the report routing system 210 may provide a recommendation for future treatment. For example, the medical report may contain a diagnosis of a medical condition. The natural language processing component 230, or another component of the system, may recognize the medical diagnosis and provide a recommendation of one or more common treatment protocols. The natural language processing component 230 may provide the recommendation based on medical treatment information, such as textbooks, journals, studies, etc, stored within the system. Alternatively, the system 200 may consult an external source of information, such as a medical database on the internet. Further, the natural language processing component 230 may detect key terms within the diagnosis and provide additional information relating to that diagnosis along with the report. For example, the natural language processing component 230 may detect a diagnosis of a particular type of heart disease. The natural language processing component 230, or some other component of the system such as the data mining component 280, may consult internal and external medical information libraries for relevant and/or new information relating to the diagnosis, treatment, and/or symptoms related to this type of heart disease. The system 200 may attach or append an electronic copy of this information to the medical report for transmittal to the intended recipients. In alternative embodiments of this invention, the medical information is only included with the medical report if the medical information reaches a certain threshold. This threshold may be based on how recently the information was published or disseminated. The threshold may also relate to how relevant the medical information is to the diagnosis.

In other alternative embodiments of the invention, relevant and/or recently published medical information may be transmitted to the intended recipients after the medical report has been transmitted recipients. For example, a user of the medical report routing system 200 may set up an alert relating to the medical report. The alert may instruct the medical report routing system 200 to transmit new and/or relevant medical information that is acquired after the medical report has been transmitted. For example, a report relating to a diagnosed heart condition may be transmitted at a certain date. Two months later, a report in a medical journal relating to that particular heart condition may be published. The alert in the system may detect that the report in the medical journal relates to the medical report containing the patient's diagnosis. The system may then transmit the report in the medical journal to one or more recipients in the list of intended recipients.

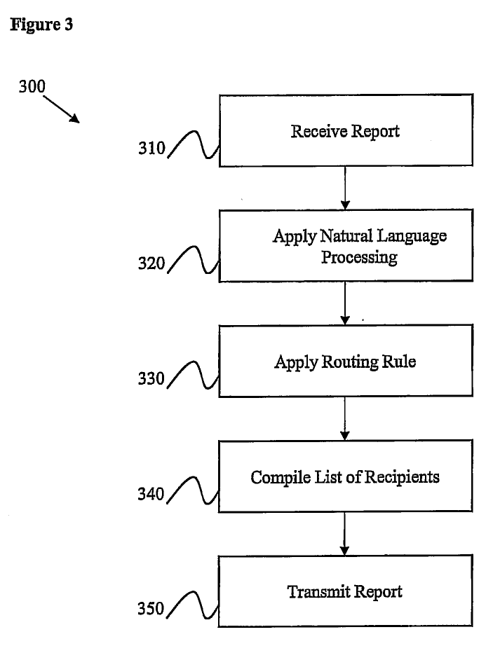

FIG. 3 illustrates a flowchart 300 for routing medical reports according to an embodiment of the present invention. At step 310, a medical report is received. As described above, the medical report may be received by a medical professional dictating the report to a rules-based routing and forwarding system. For example, a radiologist acquires images of a patient's anatomy, such as a heart. Then the radiologist examines the acquired images and prepares a report relating her diagnosis and recommendations by speaking into a microphone connected to the rules-based routing and forwarding system. Alternatively, other systems may electronically send the medical report to the rules-based routing and forwarding system.

At step 320, the data in the report undergoes natural language processing. The report data may be comprised of spoken word, handwriting, typing, images, and/or machine readable format. The report data is processed using natural language processing techniques. The natural language processing techniques may resolve ambiguities, interpret commands, and detect medical conditions and/or symptoms. For example, a radiologist's report comprising spoken words and images may be converted into a report file comprising the spoken words translated into text and images. Furthermore, certain medical terms, conditions, and/or symptoms within the report may be modified to draw attention to said terms, conditions, and/or symptoms.

At step 330, a routing rule is applied to the report. The routing rule may determine who receives a copy of the report, and also whether the recipient's report is modified in any way. For example, as described elsewhere, the routing rule may be based on a variety of factors such as the medical procedure performed, the patient's identity, the patient's primary care provider, the medical facility where the procedure was performed, the patient's medical condition, and/or the patient's health insurance. For example, the medical report may indicate that the patient suffers from an atrial defect. In that instance the routing rule may indicate that the report should be sent to one or more cardiologists. Additionally, the routing rule may influence which cardiologist, cardiology practice group, or cardiologist practice group receives a copy of the report. Alternatively, if the report indicates that the patient's heart appears normal, the routing rule may indicate that the report does not need to be sent to a cardiologist and should only be sent the patient's primary care provider and insurance provider.

At step 340, a list of intended report recipients is compiled. The list of intended recipients may be based at least in part by one or more of the previous steps. In one embodiment of the invention, the rules-based routing and forwarding system creates a list of intended recipients relevant to the data of the medical report. Continuing with the above example, the rules-based routing and transmission system may determine that the medical report may contain information relating to a certain heart pathology and include one or more cardiologists who specialize in the identified pathology in the list of intended recipients. The system may also populate the list of intended recipients based on the patient's information, such as primary care provider and insurance information. Other embodiments of the invention include transmission information relating to the intended recipients. For example, the list may include telephone numbers, email addresses, instant messenger screennames, or other information used in transmitting the report data to the intended recipient.

At step 350, the medical report is transmitted to the recipients identified by the list of intended recipients. As described above, several transmission technologies may be used. In one embodiment of the invention, the report may be electronically transmitted to one or more recipients via fax, e-mail, or through an internet webpage. The report may be transmitted to the recipients identified by the list of intended recipients described above. The intended recipients may receive the transmitted report through differing transmission technologies. Continuing with the example above, the rules-based routing and transmission system e-mails the medical report to the patient's cardiologist, faxes the medical report to the patient's general practitioner, and prints a hard copy of the medical report along with an addressed envelope for mailing to a document retention center for records storage. Other embodiments of the invention provide for an automated telephone dialing system capable of calling recipients and reading the report data over the telephone.

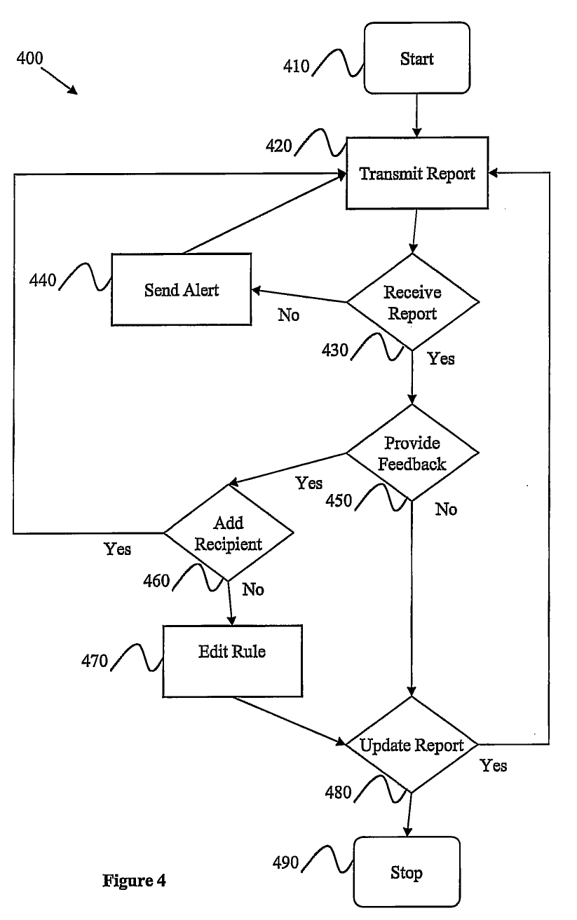

FIG. 4 illustrates a flowchart 400 for routing medical reports according to an embodiment of the present invention. At step 410, a medical report is prepared as described in other embodiments of the invention. Additionally, one or more recipients are identified by a report router and/or a routing rule as described in other embodiments of the invention.

At step 420, the medical report is transmitted to one or more recipients. The report may be transmitted via numerous transmission technologies as described elsewhere in this application.

At step 430, a check is performed to determine if the report reached its intended recipient(s). The check may take a variety of forms. In one embodiment, the report router may check if the intended recipient received the report. For example, if the report router sent the report via email, the report router may communicate with the email server to verify that the intended recipient has opened the email containing the report. In other embodiments, the recipient may acknowledge the receipt of the report. For example, if the report was received via email, the recipient may send an email response acknowledging receipt. In other embodiments of the invention, the check for receipt of the report may only be performed in critical care situations. For example, if the report was generated during a routine procedure and indicated no critical care needs, the system may not check for a receipt. In this scenario, the flowchart would skip from step 420 to step 450. Alternatively, if the report indicated that the patient required urgent medical care, the system would check for receipt. Additionally, the system can be configured to check for receipt at different time intervals. For example, the report and/or the routing rule used to modify the report could indicate that the report is urgent and must be received within one hour. Alternatively, the report may not be urgent and must be received within 48 hours. If the system determines that the report has not been received within the specified time window, the flowchart proceeds to step 440. Otherwise, if the report has been received, the report proceeds to step 450.

At step 440, if the report has not been received within the specified time interval, an alert is sent to the report router. The alert indicates that delivery of the report has failed. In one embodiment of the invention, this alert triggers the report router to attempt other delivery methods. The other delivery methods may be influenced by the routing rules described elsewhere in this application. For example, the routing rules may specify a best mode of contacting a physician. If the report router receives an alert that an urgent report has not been received by a physician within the specified time window, the report router may access the routing rule to determine if the physician has a next best mode of contact and may attempt delivery or notification via the next best mode. For example, if the routing rule specifies that the best mode of contact for a cardiologist is by email, the report router will first email the report to the cardiologist. If the report router receives an email indicating that the urgent report has not been received by the cardiologist within a 1 hour window specified by the routing rule, the report router will attempt to contact the cardiologist by the next best mode. In this example, the report router may cause an automated dialing system to call the cardiologist and cause a text to speech program to alert the cardiologist to the urgent report and/or dictate the report text to the cardiologist.

In other situations, the routing rule may specify to deliver the report to an alternate medical health professional if the first report delivery attempt fails. For example, the routing rule may specify to first transmit the report to the primary cardiologist. If the first transmission fails or is not received in time, the routing rule may specify to next transmit the report to a secondary cardiologist. After an alert specifies another transmission of the report, the flowchart returns to step 420.

At step 450, a report has been successfully received by an intended report recipient. The intended recipient has the opportunity to provide feedback to the report routing system. For example, the report recipient may wish to change one or more aspects of the report transmission. The feedback may be provided through any electronic communication system. For example, the report recipient may provide feedback to an emailed report by responding to the email with feedback. Alternatively, the report recipient may navigate to a webpage interface of the report router to customize report delivery options and/or influence routing rules. If the report recipient does not select to provide feedback to the report routing system, the flowchart proceeds to step 480. If the recipient does select to provide feedback to report routing system, the flowchart proceeds to step 460.

At step 460, the report recipient can request additional recipients to receive a copy of the report. For example, if a recipient believes they have erroneously received the report, the recipient can notify the report router. The recipient may either inform the report router of the correct report recipient or instruct the report router to select an additional recipient based on a routing rule or any other criteria. If the report was transmitted to an erroneous recipient and the routing rule does not specify any other recipients, the report router may transmit an error message to the report creator. In other circumstances, the report recipient may have properly received the report but selects an additional recipient to receive a copy of the report. If report recipient selects an additional recipient, the flowchart returns to step 420 for the additional recipient and continues to step 470 for the original recipient. If the report router does not select an additional recipient, the flowchart proceeds to step 470.

At step 470, the report recipient may edit the routing rules used in the report transmission. For example, the report recipient may select a different primary means of transmitting reports. The report recipient may also provide the routing rule with times the recipient is not available to receive reports. After step 470, the flowchart proceeds to step 480.

At step 480, the report recipient can select an option to create or receive an updated report. For example, if the report pertains to a patient with an urgent and rapidly changing condition, other health care providers may be making changes or additions to the original report. If the recipient receives the original report several hours after creation, the original report may be out of date. The recipient can request the report router to check for additional updates and if they exist to send the updated report. Alternatively the report recipient may wish to provide the report router with an updated report.

In another embodiment, the report recipient can request the report router to search for additional material to add to the report. For example, if the report pertains to a certain pathology, the report recipient can request the report router perform data mining operations related to the pathology. The report router may search for additional materials relating to the pathology and include those materials in an updated report. If an updated report is requested, the updated report transmission returns to step 420. If an updated report is requested, the flowchart ends at step 490.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above. Additionally, certain steps may be performed by a plurality of components.

Certain embodiments of the invention provide for improved systems and methods of routing medical reports. These improved system and methods offer increased efficiency by providing for automated, electronic routing and forwarding of medical reports. Additionally, automated, electronic routing allows medical reports to reach medical healthcare professionals faster than the delivery of a physical copy of the report. The reduced time and increased efficiency allows for a faster medical response, potentially saving lives and reducing the pain of patient's with urgent medical needs. Finally, the natural language processor provides for intelligent, adaptive routing and recommendation information based on the content of the medical report. Natural language processing recognizes the content of the medical report, and provides relevant routing and recommendation information in order to ensure that proper recipient receives a copy of the medical report.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A medical report routing system, the system including:
a report acquisition component adapted to receive a report, wherein said report is associated with medical data;
a language processing component adapted to process said report, wherein said language processing component applies natural language processing techniques to said report;
a routing rule component adapted to receive at least one routing rule, wherein said routing rule component is further adapted to apply said at least one routing rule to said report; and
a report transmitting component adapted to transmit said report based at least in part on said report routing component.

2. The system of claim 1, wherein said report acquisition component is further adapted to receive said report by dictation.

3. The system of claim 1, wherein said routing rule component further includes a rule editor capable of editing at least one routing rule.

4. The system of claim 1, wherein said transmitting component is further adapted to transmit said report without manual input.

5. The system of claim 1, wherein said natural language processing techniques further include speech recognition.

6. The system of claim 1, wherein said natural language processing techniques identify medical conditions based on said report.

7. The system of claim 6, wherein said routing rule component selects a list of intended recipients based at least on said medical conditions identified by said natural language processing techniques.

8. The system of claim 1 wherein said routing rule component is further adapted to compile a list of intended recipients of said medical report.

9. The system of claim 1 further including a feedback component, wherein said feedback component is adapted to receive feedback from a recipient of said report.

10. The system of claim 9 wherein said feedback component provides said feedback to said routing rule component, wherein said routing rule component modifies said routing rule based at least in part on said feedback.

11. The system of claim 1 further including a data mining component adapted to perform data mining functions based on said medical data in said report.

12. A method for automated forwarding of information, the method including:
receiving information in the form of an electronic report;
performing natural language processing on data contained within said electronic report;
compiling a list of intended recipients based on said natural language processing;
transmitting said report to at least one recipient on said list of intended recipients.

13. The method of claim 12 wherein said natural language processing selects intended recipients based on data contained in said electronic report.

14. The method of claim 12 wherein said natural language processing selects intended recipients based on patient anatomies referenced in said electronic report.

15. The method of claim 12 further including sending an alert signal indicating sread electronic report failed to be received by said at least one recipient.

16. A medical report routing system, the system including:
a report transmitting component adapted to transmit a medical report based at least in part on a report routing component;
a report feedback component adapted to receive feedback from a recipient of said medical report; and
a routing rule editing component wherein said routing rule editing component edits a routing rule based at least in part on said feedback.

17. The system of claim 16 further including a report updating component wherein said report updating component prepares an updated report for transmission at predetermined intervals.

18. The system of claim 16 wherein said routing rule editing component edits said routing rule to include additional report recipients.

19. The system of claim 16 further including an alert component adapted to indicate errors in transmitting said medical report.

20. The system of claim 17 wherein said report transmitting component transmits said medical report to an additional recipient based at least in part on output from said alert component.
